(19) United States
(12) Patent Application Publication
(10) Pub. No.: US 2009/0123170 A1
(43) Pub. Date: May 14, 2009

(54) FIXING DEVICE AND IMAGE FORMING DEVICE USING THIS

(75) Inventors: Hideki TATEMATSU, Hyogo (JP); Koichi BABA, Osaka (JP); Yukio ARAI, Saitama (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/908,001

(22) PCT Filed: Mar. 8, 2006
(86) PCT No.: PCT/JP2006/304495

§ 371 Date: Sep. 7, 2007

(30) Foreign Application Priority Data
Mar. 10, 2005 (JP) 2005-066995

(51) Int. Cl. G03G 15/20

(52) U.S. Cl. 399/68

(57) ABSTRACT

When the rotational speed of rotatable heating means for thermally fixing an image on a recording paper is changed from a first rotational speed of the highest level to a second rotational speed of the lowest level by changing the operation mode of a fixing device, the direct change from the first rotational speed to the second one may increase the overshoot of the temperature of the heating means. This shortens the life of the belt and causes an error of abnormally high temperature. To avoid an excessive overshoot of the temperature of the heating means, after the heating means is rotated for a predetermined time at a third rotational speed between the first and second rotational speeds, the rotational speed is changed to the second one.

### TECHNICAL FIELD

The present invention relates to a fixing apparatus that heats recording paper using a rotating heating section, and more particularly to a fixing apparatus that is suitable for use in an image forming apparatus such as an electrophotographic or electrostatographic copier, multifunctional apparatus, facsimile machine, or printer.

### BACKGROUND ART

An induction heating type of heating apparatus is generally used for a hot plate, electric rice-cooker, or the like. In recent years, investigations have been actively pursued into application of this kind of induction heating type of heating apparatus to a fixing apparatus in an image forming apparatus such as a copier, facsimile machine, or printer.

In a fixing apparatus that uses an induction heating type of heating apparatus, magnetic flux generated by a magnetic flux generation section is made to permeate a heat-producing layer of a heat-producing element, and the heat-producing layer is made to produce heat by means of an eddy current generated by the permeation of this magnetic flux. Then an unfixed image formed on recording paper such as copy paper or an OHP (Overhead Projector) sheet is directly or indirectly heat-fixed by heat of the heat-producing element heated by this heat production.

Specifically, for example, a heat-producing layer of electrically conductive material is formed on a heat-producing element comprising a fixing roller, fixing belt, or the like. Also, the heat-producing element and a pressure roller on either side of the recording paper feed path are positioned so as to be pressed together, forming a nip that grips and transports recording paper. Furthermore, an exciting coil is wound around a core of ferromagnetic material, forming a magnetic flux generation section, and the exciting coil is positioned opposite the heat-producing layer of the heat-producing element. Then an alternating current of predetermined frequency is applied to the exciting coil, and magnetic flux is generated around the exciting coil, forming a magnetic field. The heat-producing layer of the heat-producing element is then made to produce heat by means of an eddy current generated by the action of this magnetic field. In this state, recording paper is transported to the nip between the heat-producing element and pressure roller, and an unfixed image on the recording paper is fixed by heat of the heat-producing element heated by heat production of the heat-producing layer and pressure of the pressure roller.

An advantage of a fixing apparatus that uses this kind of induction heating type of heating section, compared with a heat roller type of fixing apparatus that uses a halogen lamp as a heat source, is that heat production efficiency is higher and the warm-up time required for heating to a predetermined fixing temperature can be shortened.

However, the heating power is great, and so in particular when heating is performed in a low-thermal-capacity fixing apparatus without rotating the apparatus, there is a risk of a localized rise in temperature, and localized thermal destruction of the roller or belt. Therefore, induction heating is limited to when the fixing apparatus is rotating. If heat is to be produced while the apparatus is in standby mode, a measure such as rotating the apparatus at low speed even in standby mode is necessary (see Patent Document 1, for example).

The print mode may be changed during continuous printing, an example being when switching from plain paper printing to OHP sheet printing. In this case, in OHP print mode the speed is normally set at half-speed in order to maintain permeability, and the temperature used for fixing is also often set higher than in plain paper print mode. Therefore, when this kind of print mode change is carried out, a phenomenon may occur whereby rises in temperature due to the above-described change of speed and change of set temperature coincide, and the temperature of the fixing apparatus temporarily exceeds the stipulated value—that is, the phenomenon of overshoot may occur.

With a conventional fixing apparatus that uses a halogen lamp, the above-described change of speed and change of set temperature are performed simultaneously. However, there is a delay in thermal response with a halogen lamp, and heating timing drifts as a result of this thermal response characteristic. That is to say, after a change of rotation speed finishes and the temperature of the heat-producing roller has stabilized, a rise in temperature of the heat-producing roller begins. Therefore, overshoot has not been considered to be a particular problem in the case of a conventional fixing apparatus using a halogen lamp.

Patent Document 1: Unexamined Japanese Patent Publication No. 2002-082549

### DISCLOSURE OF INVENTION

### Problems to be Solved by the Invention

On the other hand, there is almost no thermal response delay in an induction heating type of fixing apparatus. Therefore, when a change of speed and a change of set temperature are performed simultaneously in the same way as in a conventional fixing apparatus that uses a halogen lamp, the respective rises in temperature caused by each can be assumed to occur at the same time, resulting in a high degree of overshoot.

With an above-described conventional induction heating type of heating apparatus, the fixing apparatus is operated at half the normal print operation speed when in standby mode in consideration of the life and noise level of the fixing apparatus. Therefore, when there is no other printing to be done after plain paper printing ends, and a transition is made to standby mode, a transition is made from normal-speed operation to half-speed operation.

In this case, immediately after the transition is made to half-speed operation, the amount of heat absorbed by the pressure roller falls by half, and the temperature of the heating section overshoots. Especially, in the case of a belt-fixing type, the amount of heat supplied to a belt doubles as the speed is halves, causing a drastic rise in temperature. In a case in which the belt is made to produce heat directly by means of induction heating, also, the time taken to pass the induction heating exciting coil doubles, and a phenomenon of a localized high rise in temperature of the belt occurs.

Normally, with a belt fixing apparatus, there is a distance between the location of the heating section and the location of the temperature detecting section. Also, when induction heating is used for heating, if metal is located in the heating area, that metal will be heated, and it is therefore difficult to position a temperature sensor within the induction heating field. Consequently, a time lag occurs in feeding back a temperature reached by heating to the control section. This time lag becomes more pronounced when the speed is halved, resulting in a significant increase in the belt temperature. The above phenomenon is particularly noticeable in the case of a high constant-speed-printing belt movement speed of 200 mm/s (millimeters per second) or above, when the difference from half-speed is large.

Recently, monochrome printing has been performed at a speed of 1.1 to 2 times the color constant-speed printing speed. In this case, when a transition is made from monochrome print mode to color printing standby mode, the speed falls abruptly by approximately 50% to 25%. Consequently, greater overshoot occurs.

There is also a phenomenon whereby heating output temporarily rises when the heating target temperature is switched from the monochrome print mode value to the standby mode value. This phenomenon is pronounced when a transition from the monochrome print mode fixing temperature to the standby mode temperature means a change to a higher temperature.

When a transition is made to color printing standby mode after monochrome plain paper printing ends, the above two phenomena coincide, and a phenomenon whereby overshoot of 20° C. or more occurs is seen.

Also, when printing on OHP sheets, the operating speed is reduced and the set temperature is raised, as described above. Therefore, when a transition is made directly from monochrome printing to color OHP print mode, excessive overshoot of 25° C. or more may occur at the time of the transition, possibly resulting in shortened belt life, thermostat breakdown, and high-temperature errors.

It is an object of the present invention to provide a fixing apparatus that enables overshoot at the time of a mode transition to be suppressed, and an image forming apparatus that uses this.

### Means for Solving the Problems

A fixing apparatus of the present invention employs a configuration that includes: a rotatable heating section that fixes an image onto recording paper by means of heat; a pressure section that transports recording paper by means of pressure against the heating section; and a rotation speed control section that, when a transition is made from a mode in which the heating section rotates at a first rotation speed to another mode in which the heating section rotates at a second rotation speed, causes the heating section to rotate for a predetermined time at a third rotation speed between the first rotation speed and the second rotation speed.

A fixing apparatus of the present invention employs a configuration that includes: a rotatable heating section that fixes an image onto recording paper by means of heat; a pressure section that transports recording paper by means of pressure against the heating section; a mode switching section that switches to and sets a first mode in which the heating section rotates at a first rotation speed, a second mode in which the heating section rotates at a second rotation speed lower than the first rotation speed, and a third mode in which the heating section rotates at a third rotation speed lower than the first rotation speed and higher than the second rotation speed; and a rotation speed control section that, when switching is performed from the first mode to the second mode by the mode switching section, causes the heating section to rotate for a predetermined time at a predetermined rotation speed between the first rotation speed and the second rotation speed.

An image forming apparatus of the present invention employs a configuration that includes: an image transfer apparatus that transfers an image to recording paper; and a fixing apparatus comprising a rotatable heating section that fixes by means of heat an image transferred to recording paper by the image transfer apparatus, a pressure section that transports recording paper by means of pressure against the heating section, and a rotation speed control section that, when a transition is made from a mode in which the heating section rotates at a first rotation speed to another mode in which the heating section rotates at a second rotation speed, causes the heating section to rotate for a predetermined time at a third rotation speed between the first rotation speed and the second rotation speed.

### ADVANTAGEOUS EFFECT OF THE INVENTION

According to the present invention, when a transition is made from a mode to another mode in which the rotation speed of a heating section is different, the rotation speed is not changed directly, but instead the heating section is rotated for a predetermined time at an intermediate rotation speed, and is then caused to transit to the rotation speed of the next mode. By this means, temperature overshoot of the heating section associated with mode transition can be suppressed, and image disruption in subsequent printing can also be prevented. Therefore, for example, even with a fixing apparatus having a color printing speed, a faster monochrome printing speed, and an OHP or similar color half-speed printing speed, or a fixing apparatus that transits when on standby to a standby state in which the rotation speed of the heating section is made half-speed or lower, excessive overshoot of the heating section temperature can be prevented, and a satisfactory image obtained, when the speed is changed.

### BRIEF DESCRIPTION OF DRAWINGS

FIG. 1 is a schematic cross-sectional diagram showing the configuration of an image forming apparatus that uses a fixing apparatus according to Embodiment 1 of the present invention;

FIG. 2 is a schematic cross-sectional diagram showing the configuration of a fixing apparatus according to Embodiment 1 of the present invention;

FIG. 3 is a block diagram showing the functional configuration of a fixing apparatus according to Embodiment 1 of the present invention;

FIG. 4 is a block diagram showing the functional configuration of a calorific value control section according to Embodiment 1 of the present invention;

FIG. 5 is a flowchart showing the flow of rotation speed control processing by a rotation speed control section according to Embodiment 1 of the present invention;

FIG. 6 is a drawing showing a temperature change simulation result for a fixing belt in a fixing apparatus according to Embodiment 1 of the present invention;

FIG. 7 is a block diagram showing the functional configuration of a fixing apparatus according to Embodiment 2 of the present invention;

FIG. 8 is a flowchart showing the flow of rotation speed control processing by a rotation speed control section according to Embodiment 2 of the present invention;

FIG. 9 is an explanatory drawing showing a temperature change simulation result for a fixing belt in a fixing apparatus according to Embodiment 2 of the present invention;

FIG. 10 is a schematic cross-sectional diagram showing the configuration of a fixing apparatus according to Embodiment 3 of the present invention;

FIG. 11 is an explanatory drawing showing an example of a temperature change simulation result for a fixing apparatus that does not use an intermediate rotation speed; and

FIG. 12 is an explanatory drawing showing another example of a temperature change simulation result for a fixing apparatus that does not use an intermediate rotation speed.

### BEST MODE FOR CARRYING OUT THE INVENTION

Embodiments of the present invention will now be described in detail with reference to the accompanying drawings. In the drawings, configuration elements and equivalent parts that have identical configurations or functions are assigned the same codes, and descriptions thereof are omitted.

### Embodiment 1

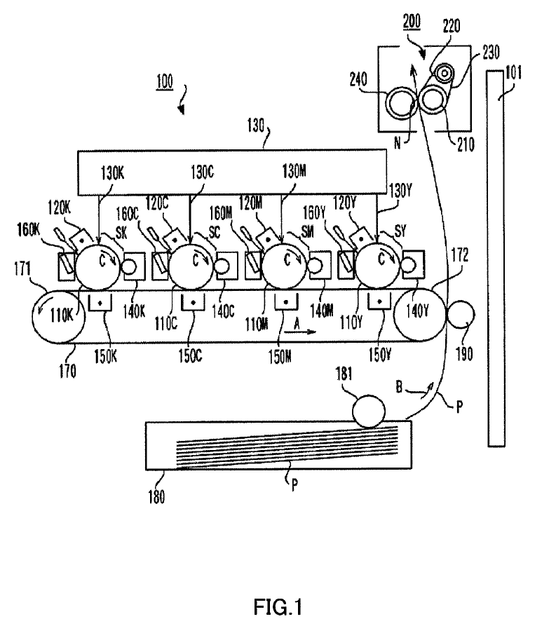

FIG. 1 is a schematic cross-sectional diagram showing the configuration of an image forming apparatus that uses a fixing apparatus according to Embodiment 1 of the present invention. This image forming apparatus 100 is a tandem type image forming apparatus. In this image forming apparatus 100, toner images of four colors contributing to the coloring of a color image are formed individually on four image bearing elements. These toner images of four colors are successively superimposed onto an intermediate transfer element as a primary image, and then blanket transfer (secondary transfer) of this primary image is performed to a recording medium.

In FIG. 1, symbols Y, M, C, and K appended to the reference codes assigned to various configuration elements of image forming apparatus 100 indicate configuration elements involved in formation of a yellow image (Y), magenta image (M), cyan image (C), and black image (K), respectively, with configuration elements assigned the same reference code having a common configuration.

Image forming apparatus 100 has photosensitive drums 110Y, 110M, 110C, and 110K functioning as the above-described four image bearing elements, and an intermediate transfer belt (intermediate transfer element) 170. Four image forming stations SY, SM, SC, and SK, are positioned respectively around photosensitive drums 110Y, 110M, 110C, and 110K. The four image forming stations SY, SM, SC, and SK are composed of four electrifiers 120Y, 120M, 120C, and 120K, an aligner (exposure apparatus) 130, four developing units 140Y, 140M, 140C, and 140K, four transfer units 150Y, 150M, 150C, and 150K, and four cleaning apparatuses 160Y, 160M, 160C, and 160K.

In FIG. 1, each of photosensitive drums 110Y, 110M, 110C, and 110K is rotated in the direction indicated by arrow C. The surfaces of photosensitive drums 110Y, 110M, 110C, and 110K are uniformly charged to a predetermined potential by electrifiers 120Y, 120M, 120C, and 120K, respectively.

The surfaces of charged photosensitive drums 110Y, 110M, 110C, and 110K are irradiated with laser beam scanning lines 130Y, 130M, 130C, and 130K corresponding to image data of different specific colors by means of aligner 130. By this means, electrostatic latent images of the aforementioned specific colors are formed on the surfaces of photosensitive drums 110Y, 110M, 110C, and 110K, respectively.

The electrostatic latent images of each of the specific colors formed on photosensitive drums 110Y, 110M, 110C, and 110K are developed by developing units 140Y, 140M, 140C, and 140K. By this means, unfixed images of the four colors contributing to the coloring of the color image are formed on photosensitive drums 110Y, 110M, 110C, and 110K.

The developed toner images of four colors on photosensitive drums 110Y, 110M, 110C, and 110K undergo primary transfer to endless intermediate transfer belt 170 functioning as the aforementioned intermediate transfer element by means of transfer units 150Y, 150M, 150C, and 150K. By this means, the toner images of four colors formed on photosensitive drums 110Y, 110M, 110C, and 110K are successively superimposed, and a full-color image is formed on intermediate transfer belt 170.

Cleaning apparatuses 160Y, 160M, 160C, and 160K remove residual toner. Residual toner is toner remaining on the surfaces of photosensitive drums 110Y, 110M, 110C, and 110K after photosensitive drums 110Y, 110M, 110C, and 110K have transferred their toner images to intermediate transfer belt 170.

Aligner 130 is installed at a predetermined angle with respect to photosensitive drums 110Y, 110M, 110C, and 110K. Also, intermediate transfer belt 170 is suspended between a drive roller 171 and idler roller 172, and is circulated in the direction indicated by arrow A in FIG. 1 by rotation of drive roller 171.

Meanwhile, at the bottom of image forming apparatus 100, a paper cassette 180 is provided in which recording paper P serving as a recording medium is held. Recording paper P is fed out from paper cassette 180 by a paper feed roller 181 one sheet at a time in the direction indicated by arrow B into a predetermined sheet path.

A transfer nip is formed between the outer surface of intermediate transfer belt 170 suspended on idler roller 172 and a secondary transfer roller 190 in contact with the outer surface of intermediate transfer belt 170. Recording paper P fed into the sheet path passes through this transfer nip. When recording paper P passes through this transfer nip, secondary transfer roller 190 performs blanket-transfer of the full-color image (unfixed image) formed on intermediate transfer belt 170 to recording paper P.

In a fixing apparatus 200 described in detail later herein, a fixing nip N is formed between the outer surface of a fixing belt 230 suspended between a fixing roller 210 and heat-producing roller 220 serving as a supporting roller, and a pressure roller 240 in contact with the outer surface of fixing belt 230. Recording paper P passes through this fixing nip N after passing through the above-described transfer nip. By this means, the unfixed full-color image blanket-transferred by the transfer nip is heat-fixed onto recording paper P.

Image forming apparatus 100 is equipped with a freely opening and closing door 101 forming part of the housing of image forming apparatus 100. Maintenance tasks such as replacement or maintenance of fixing apparatus 200, and handling of recording paper P jammed in the above-described paper transportation path, can be carried out by opening and closing this door 101.

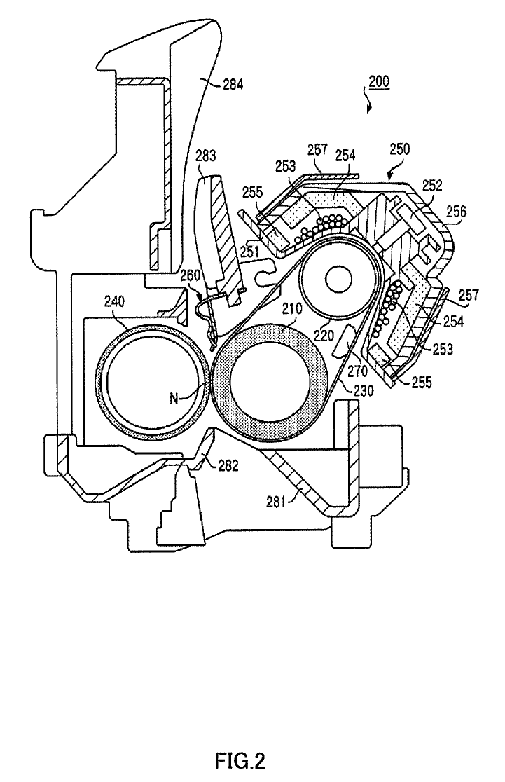

Next, fixing apparatus 200 installed in image forming apparatus 100 will be described. FIG. 2 is a schematic cross-sectional diagram showing the configuration of fixing apparatus 200 according to Embodiment 1 of the present invention.

Fixing apparatus 200 uses induction heating (IH) as a means of supplying heat. As shown in FIG. 2, fixing apparatus 200 is equipped with a fixing roller 210, heat-producing roller 220, and fixing belt 230 as a rotatable heat producing section that fixes an image onto recording paper P by means of heat supplied from a heat-supplying section. Fixing apparatus 200 also includes a pressure roller 240 as a pressure section, an induction heating apparatus 250 as a heat-supplying section, a separator 260 as a sheet separation guide plate, and four sheet guide plates 281, 282, 283, and 284 as sheet transportation path forming members.

In fixing apparatus 200, heat-producing roller 220 and fixing belt 230 are heated through the agency of a magnetic field generated by induction heating apparatus 250, and an unfixed image on recording paper P transported along sheet guide plates 281, 282, 283, and 284 is heat-fixed by fixing nip N between heated fixing belt 230 and pressure roller 240.

In FIG. 2, heat-producing roller 220 is configured as a rotating element comprising a hollow cylindrical magnetic metallic member. This magnetic metallic member is of iron, cobalt, nickel, or an alloy of these metals, for example. Heat-producing roller 220 has both ends supported in rotatable fashion by bearings fixed to supporting side plates (not shown), and rotated by a drive section (not shown). Heat-producing roller 220 has a low-thermal-capacity configuration allowing a rapid rise in temperature, with an outer diameter of 20 mm and thickness of 0.3 mm, and is regulated so that its Curie point is 300° C. or above.

Fixing roller 210 is configured with, for example, a core of stainless steel or another metal covered by a heat-resistant elastic member of solid or foam silicone rubber, with an outer diameter of about 30 mm, larger than the outer diameter of heating roller 220. The elastic member has a thickness of about 3 to 8 mm and hardness of about 15 to 50° (Asker hardness: 6 to 25° JIS A hardness).

Pressure roller 240 presses against fixing roller 210. Due to the pressure between fixing roller 210 and pressure roller 240, a fixing nip N of predetermined width is formed at the pressure location.

Fixing belt 230 is configured as a heat-resistant belt suspended between heat-producing roller 220 and fixing roller 210. Heat-producing roller 220 is induction-heated by induction heating apparatus 250 described later herein. Heat of induction-heated heat-producing roller 220 is transferred to fixing belt 230 at the area of contact between heat-producing roller 220 and fixing belt 230, and fixing belt 230 is heated all around due to its circulation.

In fixing apparatus 200 configured in this way, the thermal capacity of heat-producing roller 220 is smaller than the thermal capacity of fixing roller 210. Therefore the temperature of heat-producing roller 220 can be raised rapidly, and the warm-up time at the start of heat-fixing is shortened.

Heat-resistant fixing belt 230 has a multilayered structure, comprising a heat-producing layer, an elastic layer, and a release layer. The heat-producing layer is of a magnetic metal such as iron, cobalt, nickel, or the like, or an alloy with these as base materials. The elastic layer is of an elastic material such as silicone rubber, fluororubber, or the like, covering the surface of the heat-producing layer. The release layer is of resin or rubber with good release characteristics, such as PTFE (PolyTetraFluoroEthylene), PFA (Tetra fluoro ethylene), FEP (Polyfluoro ethylene propylene), silicone rubber, fluororubber, or the like, or a mixture of these.

Even if foreign matter should be introduced between fixing belt 230 configured in this way and heat-producing roller 220 for some reason to create a gap, the fixing belt itself can still be made to produce heat by induction heating of its heat-producing layer by induction heating apparatus 250. Since fixing belt 230 can be heated directly by induction heating apparatus 250 in this way, heating efficiency is good, and response is rapid. That is to say, there is little temperature unevenness and reliability as a heating section is high.

It is also possible to use a fixing belt without a heat-producing layer as a heating section. Although heating reliability is lower in this case, a belt of greater versatility can be used, offering an advantage in terms of cost. Such a belt could have an above-described elastic layer and release layer formed on a polyimide base material instead of a heat-producing layer, for example.

Pressure roller 240 is configured with an elastic member of high heat resistance and toner releasability fitted to the surface of a core comprising a cylindrical member of a metal with high thermal conductivity such as copper or aluminum, for example. Apart from these metals, SUS (Steel Use Stainless) (JIS: Japanese Industrial Standard) may also be used for the core of pressure roller 240.

Pressure roller 240 forms fixing nip N that grips and transports recording paper P by exerting pressure on fixing roller 210 via fixing belt 230. Here, the hardness of pressure roller 240 is greater than the hardness of fixing roller 210, and fixing nip N is formed by the peripheral surface of pressure roller 240 biting into the peripheral surface of fixing roller 210 via fixing belt 230.

For this reason, pressure roller 240 has an outer diameter of about 30 mm, the same as fixing roller 210, a thickness of about 2 to 5 mm, thinner than fixing roller 210, and hardness of about 20 to 60° (Asker hardness: 6 to 25° JIS A hardness), harder than fixing roller 210.

In fixing apparatus 200 with this kind of configuration, recording paper P is gripped and transported by fixing nip N so as to follow the surface shape of the peripheral surface of pressure roller 240, with the resultant effect that the heat-fixing surface of recording paper P separates easily from the surface of fixing belt 230.

A temperature detector 270 comprising a thermistor or similar heat-sensitive element with high thermal responsiveness, for example, is located as a heat detecting section in direct contact with the inner peripheral surface of fixing belt 230 in the vicinity of the entry side of fixing nip N.

Induction heating apparatus 250 is controlled based on the temperature of the inner peripheral surface of fixing belt 230 detected by temperature detector 270, so that the temperature when fixing an above-described unfixed image is maintained at a predetermined temperature.

Next, the configuration of induction heating apparatus 250 will be described. As shown in FIG. 2, induction heating apparatus 250 is located so as to face the outer peripheral surface of heat-producing roller 220 via fixing belt 230. Induction heating apparatus 250 is provided with a supporting frame 251 as a coil guide member of fire-resistant resin, curved so as to cover heat-producing roller 220.

A thermostat 252 is installed in the center part of supporting frame 251. Part of the temperature detecting part of thermostat 252 extends from supporting frame 251 toward heat-producing roller 220 and fixing belt 230.

Exciting coil 253 serving as a magnetic field generation section wound around the external peripheral surface of supporting frame 251 is connected to an inverter circuit (not shown). If thermostat 252 detects that the temperature of heat-producing roller 220 and fixing belt 230 is abnormally high, it forcibly breaks the connection between exciting coil 253 and the inverter circuit.

Exciting coil 253 comprises a single long exciting coil wire with an insulated surface wound alternately in the axial direction of heat-producing roller 220 along supporting frame 251. The length of the wound part of this exciting coil 253 in the axial direction is approximately the same as the length of the area of contact between fixing belt 230 and heat-producing roller 220.

Exciting coil 253 is connected to the above-mentioned inverter circuit, and generates an alternating field by being supplied with a high-frequency alternating current of 10 kHz to 1 MHz (preferably, 20 kHz to 800 kHz). This alternating field acts upon the heat-producing layers of heat-producing roller 220 and fixing belt 230 in the area of contact between heat-producing roller 220 and fixing belt 230 and its vicinity. Through the agency of this alternating field, an eddy current flows within the heat-producing layers of heat-producing roller 220 and fixing belt 230 in a direction that prevents variation of the alternating field.

This eddy current generates Joule heat corresponding to the resistance of the heat-producing roller 220 and fixing belt 230 heat-producing layers, and causes induction heating of heat-producing roller 220 and fixing belt 230 mainly in the area of contact between heat-producing roller 220 and fixing belt 230 and its vicinity.

On the other hand, an arch core 254 and side core 255 are provided on supporting frame 251 so as to surround exciting coil 253. Arch core 254 and side core 255 increase the inductance of exciting coil 253 and provide good electromagnetic coupling of exciting coil 253 and heat-producing roller 220.

Therefore, in this fixing apparatus 200, it is possible to apply a larger amount of power to heat-producing roller 220 with the same coil current through the agency of arch core 254 and side core 255. This enables the heat-producing roller 220 and fixing belt 230 warm-up time to be shortened.

Supporting frame 251 is also provided with a resin housing 256. This housing 256 is formed in the shape of a roof so as to cover arch core 254 and thermostat 252 inside induction heating apparatus 250. A plurality of heat release vents (not shown) are formed in this housing 256, allowing housing 256 to release externally heat generated by supporting frame 251, exciting coil 253, arch core 254, and so forth. Housing 256 may be formed of a material other than resin, such as aluminum, for example.

Supporting frame 251 is also provided with a short ring 257 that covers the outer surface of housing 256. This short ring 257 is positioned so that the heat release vents formed in housing 256 are not blocked. Short ring 257 is located on the rear of arch core 254, and generates an eddy current in a direction in which slight leakage flux leaked externally from the rear of arch core 254 is canceled out. By this means, a magnetic field is generated in a direction in which the magnetic field of leakage flux is cancelled out, and unwanted emission due to leakage flux is prevented.

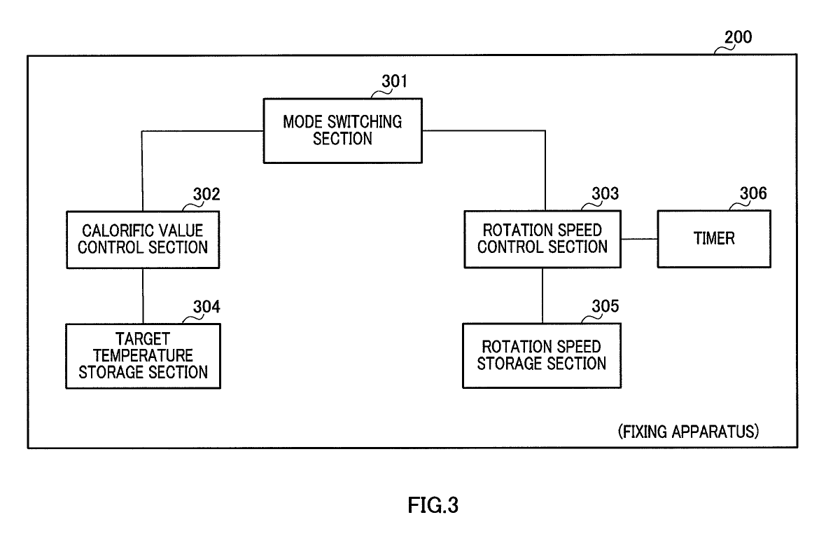

FIG. 3 is a block diagram showing the functional configuration of fixing apparatus 200. Fixing apparatus 200 is mainly composed of a mode switching section 301, a calorific value control section 302, a rotation speed control section 303, a target temperature storage section 304, a rotation speed storage section 305, and a timer 306. Mode switching section 301 performs setting and switching of the operation mode of image forming apparatus 100. Calorific value control section 302 controls the calorific value of fixing apparatus 200. Rotation speed control section 303 controls the rotation speed of heat-producing roller 220 and fixing belt 230. Target temperature storage section 304 stores in advance target temperatures of heat-producing roller 220 and fixing belt 230 set for each operation mode of image forming apparatus 100. Rotation speed storage section 305 stores in advance fixing belt 230 rotation speeds set for each operation mode of image forming apparatus 100. Timer 306 is used by rotation speed control section 303 in rotation speed control processing described later herein.

Although not shown in the drawings, fixing apparatus 200 is also provided with a CPU (Central Processing Unit), a storage medium such as ROM (Read Only Memory) that stores a control program, working memory such as RAM (Random Access Memory), and circuits such as an AD (Analog to Digital) converter. The functions of the sections shown in FIG. 3 are implemented by execution of a predetermined control program by the CPU.

First, the function of mode switching section 301 will be described. Mode switching section 301 switches to and sets a monochrome plain paper print mode (herein after referred to as “monochrome print mode” or “plain paper print mode” as appropriate) for printing a monochrome image on plain paper, a color plain paper print mode for printing a color image on plain paper, or a standby mode in which printing is not performed but the heating section is warmed up. This switching is performed based on a print operation start directive from a host apparatus (not shown) such as a user's personal computer, operation of a key switch (not shown) provided on image forming apparatus 100, detection of the end of printing using a paper ejection sensor (not shown), and so forth.

When a print mode is specified and a print operation start directive is given by a host apparatus, image forming apparatus 100 shown in FIG. 1 starts an image forming operation described above with reference to FIG. 1 and FIG. 2. At this time, mode switching section 301 controls each section of image forming apparatus 100 so that each section performs an operation corresponding to the specified print mode. Mode switching section 301 notifies calorific value control section 302 and rotation speed control section 303 of the specified print mode. When the end of printing is detected by the paper ejection sensor, mode switching section 301 switches the operation of each section of image forming apparatus 100 to standby mode. At this time, mode switching section 301 notifies calorific value control section 302 and rotation speed control section 303 of the transition to standby mode.

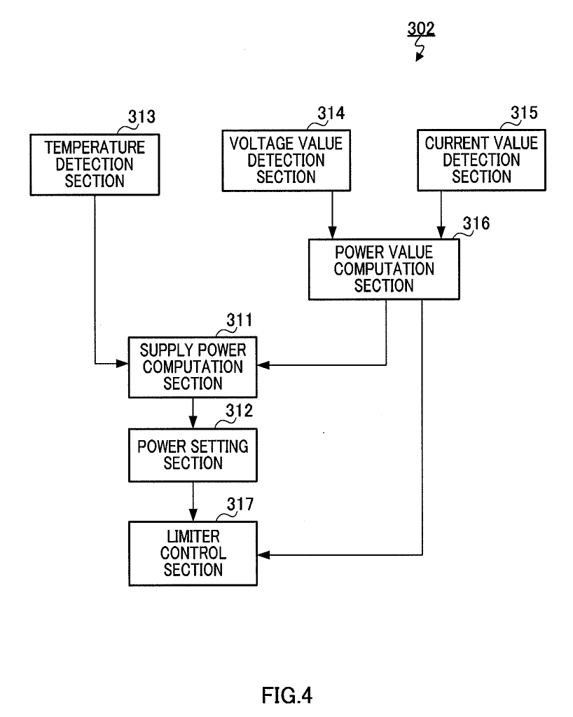

Next, the configuration and function of calorific value control section 302 of fixing apparatus 200 according to this embodiment will be described. FIG. 4 is a block diagram showing the functional configuration of calorific value control section 302.

As shown in FIG. 4, calorific value control section 302 is mainly composed of a supply power computation section 311, a power setting section 312, a temperature detection section 313, a voltage value detection section 314, a current value detection section 315, a power value computation section 316, and a limiter control section 317.

As already explained, induction heating apparatus 250 shown in FIG. 2 heats heat-producing roller 220 and fixing belt 230 in order to heat-fix an unfixed full-color image that has undergone secondary transfer to recording paper P. Supply power computation section 311 computes the value of power to be supplied to induction heating apparatus 250.

Power setting section 312 outputs the power value calculated by supply power computation section 311 to the above-mentioned inverter circuit that drives exciting coil 253.

The value of power output to the inverter circuit is controlled according to a value (register value) set in this power setting section 312. The calorific value of induction heating apparatus 250—that is, the temperature of heat-producing roller 220 and fixing belt 230 for fixing an unfixed image onto recording paper P—is controlled by means of this power value control.

Information necessary for computing the value of power supplied to induction heating apparatus 250 includes the image fixing temperature of fixing apparatus 200 and the value of power actually being supplied to the inverter circuit. The image fixing temperature of fixing apparatus 200 is obtained from temperature detection section 313, and the value of power actually being supplied to the inverter circuit is obtained from power value computation section 316.

Temperature detection section 313 converts analog output from temperature detector 270 to digital data, and outputs this to supply power computation section 311. As stated above, temperature detector 270 is located in direct contact with the inner surface of fixing belt 230 in the vicinity of the entry side of fixing nip N.

Although not shown in FIG. 2, fixing apparatus 200 is provided with a voltage detector that detects the voltage input to the inverter circuit, and a current detector that detects the current input to the inverter circuit. Voltage value detection section 314 converts the voltage detector detection result to digital data, and outputs an inverter circuit input voltage value. Current value detection section 315 converts the current detector detection result to digital data, and outputs an inverter circuit input current value. With regard to the current value, it is also possible for the value of the current flowing in exciting coil 253 to be detected and used for control.

Power value computation section 316 finds the inverter circuit input power value by multiplying together the outputs from voltage value detection section 314 and current value detection section 315.

Power value computation section 316 outputs the computation result to supply power computation section 311.

Each time a mode notification is given by mode switching section 301, supply power computation section 311 references target temperature storage section 304 and acquires the relevant target temperature. Then supply power computation section 311 acquires data from temperature detection section 313 and data from power value computation section 316 and sets a computed value (register value) in power setting section 312 periodically (here, every 10 ms), so that the temperature of heat-producing roller 220 and fixing belt 230 matches the acquired target temperature. Specifically, supply power computation section 311 controls magnetic flux generated by exciting coil 253 by adjusting the register value. Thus, the temperature of heat-producing roller 220 and fixing belt 230 for fixing an unfixed image onto recording paper P is controlled by having supply power computation section 311 set a computed value in power setting section 312.

Limiter control section 317 performs a final check of a power value set in power setting section 312. That is to say, if an attempt is made to set a value exceeding a predetermined limit value in power setting section 312, or if a power value computation section 316 computation result is greater than a predetermined value, limiter control section 317 performs control to change the data to be set in power setting section 312 to a predetermined stipulated value.

To be more specific, if, for example, the limit value is AAHEX (HEXadecimal number), and the value computed by supply power computation section 311 is greater than AAHEX, limiter control section 317 forcibly sets a power value equivalent to 80% of the target power as the value to be set in power setting section 312. Limiter control section 317 also performs the same kind of processing if the supply power computation section 311 computation result is 1150 W (watts) or higher, for example.

Actually, a power value that is set is limited by an upper limit and a lower limit, and therefore should not reach a limit value such as described above. However, it is desirable for this kind of limit control to be included to provide for a case in which noise occurs on the line of the AD converter used to acquire a current value and voltage value, and data is detected incorrectly.

Next, the function of rotation speed control section 303 will be described, preceded by a description of the storage contents of rotation speed storage section 305. Rotation speed storage section 305 stores a rotation speed of 250 mm/s for plain paper print mode, a rotation speed of 150 mm/s for color plain paper print mode, and a rotation speed of 100 mm/s for standby mode. Hereinafter, 250 mm/s is referred to as the first rotation speed, and 100 mm/s as the second rotation speed. Rotation speed storage section 305 also stores a third rotation speed of 170 mm/s as an intermediate rotation speed between the first rotation speed and the second rotation speed.

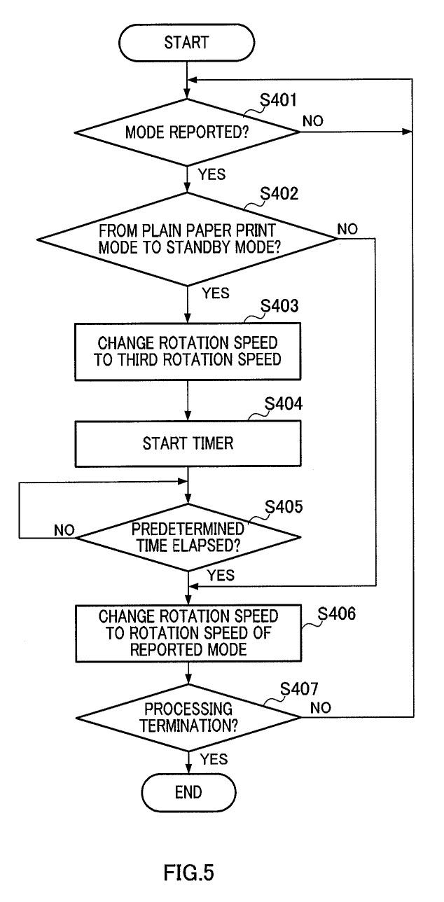

FIG. 5 is a flowchart showing the flow of rotation speed control processing by rotation speed control section 303. If a mode is reported from mode switching section 301 (S401: YES), and the immediately preceding mode was plain paper print mode and standby mode has been reported (S402: YES), rotation speed control section 303 changes the rotation speed of heat-producing roller 220 and fixing belt 230 to the third rotation speed (S403). Then time measurement by timer 306 is started (S404), and when the measured time reaches a predetermined time (S405: YES), the rotation speed of heat-producing roller 220 and fixing belt 230 is changed to the rotation speed of the reported mode (S406). One second, for example, may be set as this predetermined time. Then, if, for example, the mode is fixed and termination of processing is directed (S407: YES), the series of processing steps is terminated, but if termination of processing is not specifically directed (S407: NO), the processing flow returns to step S401 again.

On the other hand, if a mode is reported from mode switching section 301 (S401: YES), but the immediately preceding mode was not plain paper print mode, or if the reported mode is not standby mode (S402: NO), the processing flow proceeds directly to step S406, and a change is made directly to the rotation speed of the reported mode without changing to the third rotation speed.

For the predetermined time used as a threshold value in step S405, a length of time within which the magnitude of overshoot does not exceed a predetermined permitted value can be identified and applied. Identification of this length of time can be achieved, for example, by measuring the magnitude of overshoot that occurs in an experiment or simulation while gradually shortening the length of time for which rotation is performed at the third rotation speed. The ambient temperature may also be detected, and the predetermined time adjusted to a suitable value according to the detection result.

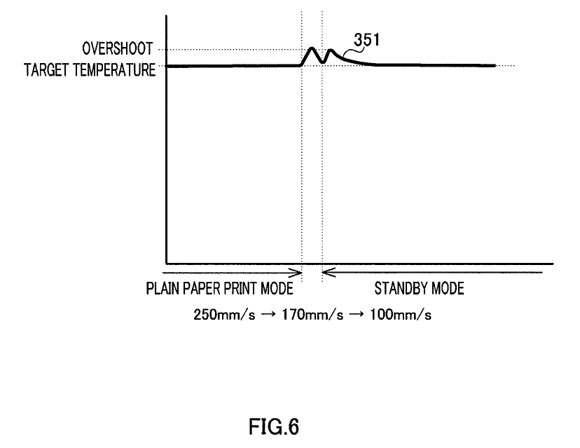

FIG. 6 is a drawing showing a temperature change simulation result for fixing belt 230 in fixing apparatus 200 according to this embodiment. The simulation result shown here is for a case in which printing is performed with the image forming apparatus 100 mode set to plain paper print mode, and a transition is made to standby mode when that printing ends.

In fixing apparatus 200, preheating is performed in order to shorten the time until initial printing becomes possible after returning from standby mode. As explained above, fixing apparatus 200 is an external-coil type of belt fixing apparatus using induction heating as a heat source, configured so that a part of fixing belt 230 and heat-producing roller 220 is heated, and heat is transferred to the whole of fixing belt 230 through the rotation of fixing belt 230 and heat-producing roller 220. With this configuration, if preheating is performed while heat-producing roller 220 and fixing belt 230 are stationary there is a possibility of part of the belt reaching a high temperature and being destroyed, and therefore preheating must be carried out while these parts of the apparatus are rotating. At the same time, taking the life of fixing apparatus 200 and so forth into consideration, it is desirable to avoid unnecessary rotation of heat-producing roller 220 and fixing belt 230.

Therefore, with this fixing apparatus 200, the rotation speed of the print mode for which the slowest rotation speed is set is used as the rotation speed in standby mode. Hereinafter, the rotation speed of fixing belt 230 will be taken to be denoted by the speed of movement of the outer periphery of fixing belt 230.

As stated above, the rotation speed of heat-producing roller 220 and fixing belt 230 is 250 mm/s in monochrome print mode and 100 mm/s in standby mode.

As explained above, in fixing apparatus 200, heat of heat-producing roller 220 is transferred to fixing belt 230. Alternatively, fixing belt 230 is heated in a particular area by induction heating or the like, and heat is conveyed to fixing nip N. Therefore, the moment the rotation speed changes to a lower speed due to a change of print mode or the like, the time taken for fixing belt 230 to pass through the heated area increases, and the amount of heat per unit time supplied to fixing belt 230 also increases. Although the amount of heating is subsequently controlled to an appropriate amount by measurement of the additional amount of heat, major overshoot of the temperature of fixing belt 230 occurs temporarily.

Infixing apparatus 200, if the ratio of the fixing belt 230 rotation speed before and after a mode transition is 0.5 or less, rotation is performed for a predetermined time at an intermediate rotation speed. In a case in which a transition is made from the fastest first rotation speed of 250 mm/s to the slowest second rotation speed of 100 mm/s, the ratio is less than 0.5. Therefore, when a transition is made from plain paper monochrome print mode to standby mode, after plain paper printing the apparatus operates for one second at the third rotation speed of 170 mm/s, a speed intermediate between the above two speeds, and then changes the rotation speed to 100 mm/s. By this means, it is possible to suppress the occurrence of major overshoot in the temperature of heat-producing roller 220 and fixing belt 230 when the rotation speed of fixing belt 230 changes to a lower speed.

In this case, as shown in FIG. 6, there are two overshoot peaks in fixing belt 230 temperature curve 351, and the difference in temperature with respect to the target temperature in plain paper print mode and standby mode is limited to about 6° C.

The rotation speed in the color plain paper print mode of fixing apparatus 200 is 150 mm/s. When a transition is made from monochrome print mode to color plain paper print mode, the rotation speed of fixing belt 230 changes from 250 mm/s to 150 mm/s, and thus the speed ratio is not less than or equal to 0.5. In this case, therefore, the rotation speed is changed directly from 250 mm/s to 150 mm/s without a transition through an intermediate speed.

As described above, according to fixing apparatus 200 of this embodiment, when switching is performed from a certain mode to another mode in which the rotation speed of the heating section decreases greatly, the rotation speed of the heating section is not changed directly, but instead an interval is provided in which rotation is performed at an intermediate rotation speed. By this means, the occurrence of major overshoot in the temperature of heat-producing roller 220 and fixing belt 230 can be suppressed, the reliability of the apparatus can be improved, and the life of the apparatus can be extended.

In this embodiment, fixing apparatus 200 has been described as being installed in a tandem type image forming apparatus 100, but this is not a limitation, and it is possible for fixing apparatus 200 to be installed in any type of image forming apparatus. Also, a fixing apparatus 200 that uses a fixing belt 230 as a heating section has been described by way of example, but this is not a limitation, and a configuration may also be used in which fixing belt 230 is not used, and fixing roller 210 doubles as heat-producing roller 220. That is to say, a configuration may also be used in which an unfixed image on recording paper P is heat-fixed directly by means of fixing roller 210.

### Embodiment 2

Next, a fixing apparatus according to Embodiment 2 of the present invention will be described. Below, descriptions of parts that have the same configuration or perform the same operation as in Embodiment 1 are omitted, and elements that have the same function as in Embodiment 1 are assigned the same codes. A fixing apparatus according to Embodiment 2 is applied to the same kind of image forming apparatus as shown in FIG. 1 of Embodiment 1, and its configuration is the same as in FIG. 2 of Embodiment 1. However, the functional configuration differs from that of a fixing apparatus according to Embodiment 1.

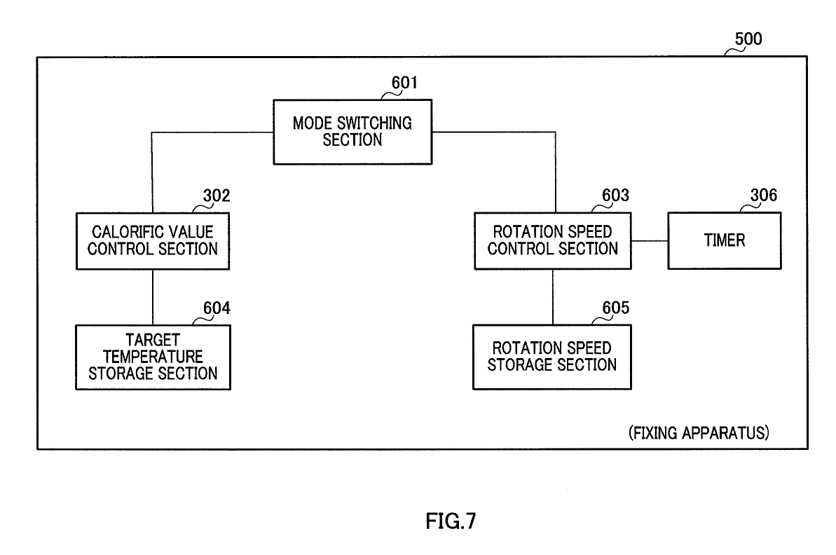

FIG. 7 is a block diagram showing the functional configuration of a fixing apparatus according to Embodiment 2 of the present invention, and corresponds to FIG. 3 of Embodiment 1. This fixing apparatus 500 is provided with a mode switching section 601 that, in addition to the same monochrome plain paper print mode, color plain paper print mode, and standby mode as in Embodiment 1, also sets a color special paper print mode for performing printing on an OHP sheet. Also, since the printing speeds in each print mode differ from Embodiment 1, this fixing apparatus 500 has a target temperature storage section 604 and rotation speed storage section 605 whose storage contents differ from those of target temperature storage section 304 and rotation speed storage section 305 in Embodiment 1. Furthermore, this fixing apparatus 500 has a rotation speed control section 603 that performs different processing from that of rotation speed control section 303 of Embodiment 1.

Rotation speed storage section 605 stores a rotation speed of 170 mm/s for monochrome print mode, a rotation speed of 105 mm/s for color plain paper print mode, and a rotation speed of 52.5 mm/s for color special paper print mode and standby mode. Hereinafter, 170 mm/s is referred to as the first rotation speed, 52.5 mm/s as the second rotation speed, and 105 mm/s as the third rotation speed.

Target temperature storage section 604 stores, for example, a target temperature of 170° C. for monochrome print mode, and a target temperature of 175° C. for color plain paper print mode. With regard to the target temperature in standby mode, the higher temperature is used as a standard in order to shorten the first-print time. Therefore, target temperature storage section 604 stores a target temperature of 175° C. for standby mode.

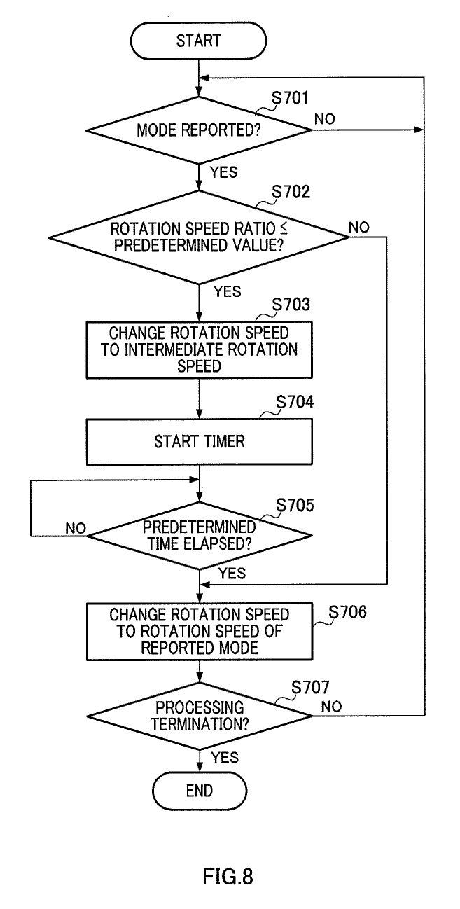

FIG. 8 is a flowchart showing the flow of rotation speed control processing by rotation speed control section 603 and corresponds to FIG. 5. When a mode is reported from mode switching section 601 (S701: YES), rotation speed control section 603 determines whether or not the ratio of the rotation speed of the reported mode to the rotation speed of the immediately preceding mode is less than or equal to a predetermined value (S702). This predetermined value may be set to 0.5, for example.

If the rotation speed ratio is less than or equal to the predetermined value (S702: YES), rotation speed control section 603 determines that temperature overshoot will become excessive, and changes the rotation speed of heat-producing roller 220 and fixing belt 230 to a rotation speed between the rotation speed of the immediately preceding mode and the rotation speed of the reported mode (S703).

Then rotation speed control section 303 starts time measurement by timer 306 (S704), and when the measured time reaches a predetermined time (S705: YES), changes the rotation speed of heat-producing roller 220 and fixing belt 230 to the rotation speed of the reported mode (S706). One second, for example, may be set as this predetermined time. Then, if termination of processing is directed—for example, if the mode is fixed—(S707: YES), the series of processing steps is terminated, but if termination of processing is not specifically directed (S707: NO), the processing flow returns to step S701 again. The determination in step S702 and the rotation speed determination after a change in step S703 and step S706 are performed by referencing rotation speed storage section 605.

On the other hand, if the ratio of the rotation speed of the reported mode to the rotation speed of the immediately preceding mode is not less than or equal to the predetermined value (S702: NO), the processing flow proceeds directly to step S706, and a change is made directly to the rotation speed of the reported mode without changing to an intermediate rotation speed.

For the predetermined value used as a threshold value in step S702, a speed ratio for which the magnitude of overshoot does not exceed a predetermined permitted value can be identified and applied. Identification of the speed ratio can be achieved, for example, by measuring the magnitude of overshoot that occurs in an experiment or simulation for various combination patterns of pre-change rotation speed and post-change rotation speed, and analyzing the relationship between the respective speed ratios and overshoot magnitudes. The ambient temperature may also be detected, and the predetermined value adjusted to a suitable value according to the detection result. Also, in step S702, it may be determined whether or not the rotation speed ratio is smaller than a predetermined value rather than determining whether or not the rotation speed ratio is less than or equal to a predetermined value. In this case, the processing flow proceeds to step S703 if the rotation speed ratio is smaller than the predetermined value, or proceeds to step S706 if the rotation speed ratio is not smaller than the predetermined value.

Also, for the predetermined time used as a threshold value in step S705, the relationship to a speed ratio of post-change rotation speed to pre-change rotation speed may be analyzed in an experiment or simulation, and a common value applied such that overshoot is within a permitted range for all speed ratios based on the analysis result. Alternatively, a minimum value at which overshoot is within a permitted range may be identified for each speed ratio, and that minimum value applied on an individual speed ratio basis. The ambient temperature may also be detected, and the predetermined time adjusted to a suitable value according to the detection result.

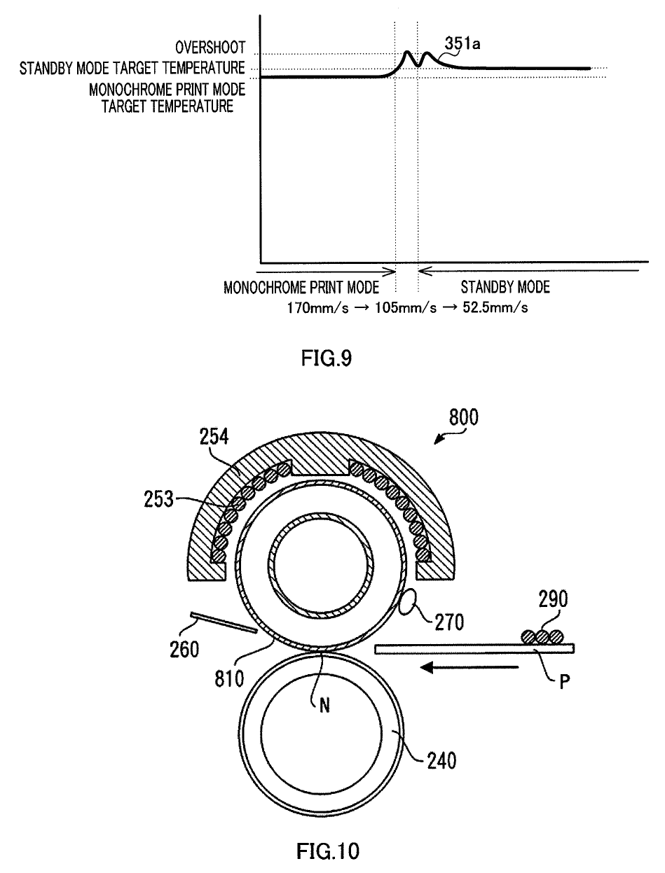

FIG. 9 is an explanatory drawing showing a temperature change simulation result for fixing belt 230 in fixing apparatus 500 according to this embodiment. The simulation result shown here is for a case in which printing is performed with the image forming apparatus 100 mode set to monochrome print mode, and a transition is made to standby mode when that printing ends.

In this case, the rotation speed falls from the first rotation speed of 170 mm/s to the second rotation speed of 52.5 mm/s. When the speed ratio is 0.5 or less even though the absolute value of the first rotation speed is low, as in this case, major overshoot occurs in the temperature of fixing belt 230. Thus, during the transition from monochrome print mode to standby mode, rotation is performed for one second at the third rotation speed of 105 mm/s, which is the printing speed for color plain paper print mode. By this means, overshoot peak dispersion can be achieved, and overshoot can be reduced. A speed change from the first rotation speed of 170 mm/s to the third rotation speed of 105 mm/s, and a speed change from the third rotation speed of 105 mm/s to the second rotation speed of 52.5 mm/s, are performed directly without intervening rotation at an intermediate rotation speed.

When a transition is made from monochrome print mode to standby mode, the fixing temperature setting is changed from 170° C. to 175° C. However, when the target temperature is changed from a lower temperature to a higher temperature in this way, power supplied to induction heating apparatus 250 increases temporarily, and fixing belt 230 temperature overshoot also increases.

Thus, in fixing apparatus 200 of this embodiment, when the rotation speed of fixing belt 230 is changed from 170 mm/s to 105 mm/s, the target temperature is first changed, and the rotation speed is changed to 52.5 mm/s after an elapse of time equivalent to the above-described predetermined value.

In this case, as shown in FIG. 9, there are two overshoot peaks in fixing belt 230 temperature curve 351a, and the difference in temperature with respect to the target temperature for standby mode can be limited to about 7° C. As a result, convergence to the standby mode target temperature can be performed rapidly.

### Embodiment 3

Next, a fixing apparatus according to Embodiment 3 of the present invention will be described. Below, descriptions of parts that have the same configuration or perform the same operation as in Embodiment 1 are omitted, and elements that have the same function as in Embodiment 1 are assigned the same codes. A fixing apparatus according to Embodiment 3 is applied to the same kind of image forming apparatus as shown in FIG. 1 of Embodiment 1.

FIG. 10 is a schematic cross-sectional diagram showing the configuration of a fixing apparatus 800 according to Embodiment 3 of the present invention. Fixing apparatus 800 has a roller configuration instead of a belt configuration, but employs an external-heating induction heating method. Specifically, a fixing roller 810 has the same kind of heat-producing layer as heat-producing roller 220 of Embodiment 1. The outer peripheral surface of fixing roller 810 is in contact with the outer peripheral surface of pressure roller 240, and forms a nip N that grips and transports recording paper P to which toner 290 has been transferred. The same kind of exciting coil 253 as in Embodiment 1 is positioned opposite the outer peripheral surface of fixing roller 810 at a location away from nip N, and an arch core 254 is positioned so as to surround exciting coil 253. That is to say, fixing apparatus 800 has a configuration whereby a part of fixing roller 810 is heated rapidly, and the entire outer peripheral surface of fixing roller 810 is heated by rotating fixing roller 810.

Since this fixing apparatus 800 has a configuration whereby apart of fixing roller 810 is heated, and a temperature detector 270 is positioned downstream of the heated part, there is a time lag between heating and associated temperature measurement. Therefore, if the rotation speed of fixing roller 810 decreases suddenly, only a part of fixing roller 810 is heated rapidly, and an abnormally high temperature may result. However, by executing the control shown in FIG. 5, temperature overshoot when the rotation speed of fixing roller 810 is changed can be reduced, and a temperature change simulation result comparable to that in FIG. 6 can be obtained.

### Comparison Example 1

Next, to provide a comparison for reference, a description of a temperature change simulation result when an intermediate rotation speed is not used in the fixing apparatus described in Embodiment 1 will be given as Comparison Example 1.

In this Comparison Example 1, the third rotation speed of Embodiment 1 was not used, and the rotation speed of fixing belt 230 was changed directly from the plain paper print mode first rotation speed of 250 mm/s to the standby mode second rotation speed of 100 mm/s. FIG. 11 is an explanatory drawing showing a fixing belt 230 temperature change simulation result according to this Comparison Example 1. When a mode transition was made, major overshoot occurred in fixing belt 230 temperature curve 351b due to the change of speed, and the temperature difference with respect to the target temperature in plain paper print mode and standby mode was approximately 20° C.

### Comparison Example 2

Next, to provide a comparison for reference, a description of a temperature change simulation result when an intermediate rotation speed is not used in the fixing apparatus described in Embodiment 2 will be given as Comparison Example 2.

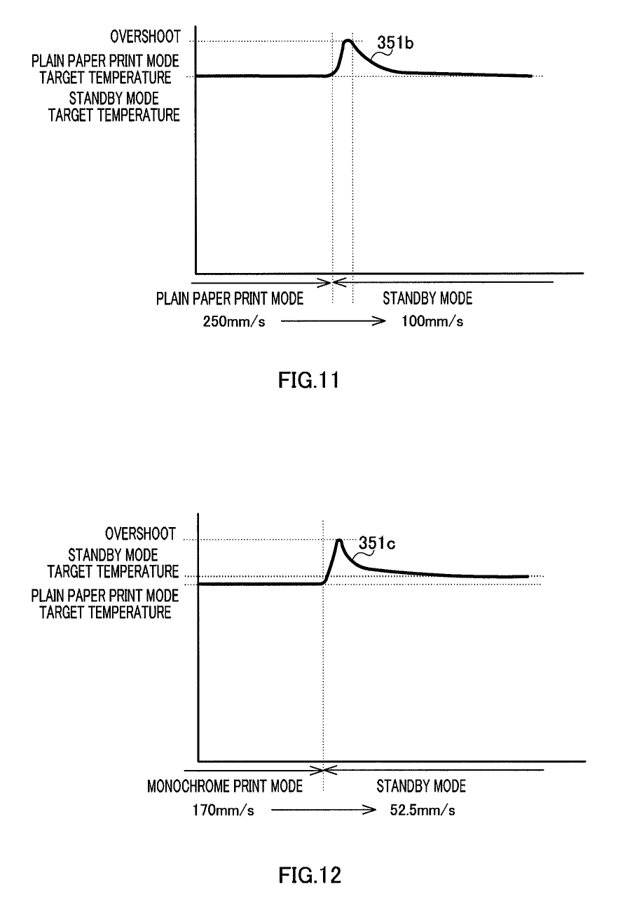

In this Comparison Example 2, the third rotation speed of Embodiment 2 was not used, and the rotation speed of fixing belt 230 was changed directly from the monochrome print mode first rotation speed of 170 mm/s to the standby mode second rotation speed of 52.5 mm/s. FIG. 12 is an explanatory drawing showing a fixing belt 230 temperature change simulation result according to this Comparison Example 2. When a mode transition was made, major overshoot occurred in fixing belt 230 temperature curve 351c due to the change of rotation speed and change of target temperature, and the temperature difference with respect to the target temperature in standby mode was approximately 25° C.

At this time the temperature of fixing belt 230 is 200° C. or higher, but the temperature of fixing belt 230 may reach 205° C. or higher if temperature compensation is implemented in a low-temperature environment. As a result, there is a risk of a high-temperature error occurring due to thermistor variance, causing abnormal stoppage of the fixing apparatus. According to the fixing apparatuses of Embodiments 1 through 3 of the present invention, not only can heating section temperature overshoot be reduced, but these events, which may occur with a conventional method, can be prevented.

The present application is based on Japanese Patent Application No. 2005-066995 filed on Mar. 10, 2005, entire content of which is expressly incorporated herein by reference.

### INDUSTRIAL APPLICABILITY

A fixing apparatus according to the present invention enables temperature overshoot of a heating apparatus to be kept small, and is therefore suitable for use as a fixing apparatus of an image forming apparatus such as a copier, facsimile machine, or printer.

1. A fixing apparatus comprising:
a rotatable heating section that fixes an image onto recording paper by means of heat;
a pressure section that transports recording paper by means of pressure against said heating section; and
a rotation speed control section that, when a transition is made from a mode in which said heating section rotates at a first rotation speed to another mode in which said heating section rotates at a second rotation speed, causes said heating section to rotate for a predetermined time at a third rotation speed between the first rotation speed and the second rotation speed.

2. The fixing apparatus according to claim 1, wherein said rotation speed control section, when a ratio of the second rotation speed to the first rotation speed is smaller than a predetermined value, causes said heating section to rotate for a predetermined time at the third rotation speed, and then changes a rotation speed of said heating section from the predetermined rotation speed to a rotation speed corresponding to the other mode.

3. The fixing apparatus according to claim 2, wherein said rotation speed control section, when a ratio of the second rotation speed to the first rotation speed is greater than or equal to the predetermined value, changes a rotation speed of said heating section directly from the first rotation speed to the second rotation speed.

4. The fixing apparatus according to claim 2, wherein the predetermined value is 0.5.

5. A fixing apparatus comprising:
a rotatable heating section that fixes an image onto recording paper by means of heat;
a pressure section that transports recording paper by means of pressure against said heating section;
a mode switching section that switches to and sets a first mode in which said heating section rotates at a first rotation speed, a second mode in which said heating section rotates at a second rotation speed lower than the first rotation speed, and a third mode in which said heating section rotates at a third rotation speed lower than the first rotation speed and higher than the second rotation speed; and
a rotation speed control section that, when switching is performed from the first mode to the second mode by said mode switching section, causes said heating section to rotate for a predetermined time at a predetermined rotation speed between the first rotation speed and the second rotation speed.

6. The fixing apparatus according to claim 5, wherein said rotation speed control section, after causing said heating section to rotate for a predetermined time at a predetermined rotation speed between the first rotation speed and the second rotation speed, changes a rotation speed of said heating section from the predetermined rotation speed to the second rotation speed.

7. The fixing apparatus according to claim 5, wherein the predetermined rotation speed is the third rotation speed.

8. The fixing apparatus according to claim 7, wherein said rotation speed control section, when switching is performed from the first mode to the second mode by said mode switching section, after changing a rotation speed of said heating section from the first rotation speed to the third rotation speed and causing rotation to be performed for a predetermined time, changes a rotation speed of said heating section to the second rotation speed.

9. The fixing apparatus according to claim 5, wherein said rotation speed control section, when switching is performed from the first mode to the third mode by said mode switching section, changes a rotation speed of said heating section directly from the first rotation speed to the third rotation speed.

10. The fixing apparatus according to claim 5, wherein said rotation speed control section, when switching is performed from the third mode to the second mode by said mode switching section, changes a rotation speed of said heating section directly from the third rotation speed to the second rotation speed.

11. The fixing apparatus according to claim 5, wherein:
said heating section conveys heat by means of rotation and fixes an image on recording paper, and
said fixing apparatus further comprises:
a target temperature setting section that, in said each mode, sets a heat conveyance area of said heating section according to said each mode; and
a heat-supplying section that supplies heat to said heating section according to a target temperature set by the target temperature setting section.

12. The fixing apparatus according to claim 5, wherein:
the first mode corresponds to a monochrome plain paper print mode;
the first rotation speed is a rotation speed of said heating section that corresponds to a monochrome plain paper printing speed;
the second mode corresponds to a standby mode in which printing is not performed;
the second rotation speed is a rotation speed of said heating section that corresponds to a rotation speed in standby mode;
the third mode corresponds to a color plain paper print mode;
the third rotation speed is a rotation speed of said heating section that corresponds to a color plain paper printing speed; and
the second rotation speed is a rotation speed of one-half or less of the first rotation speed.

13. The fixing apparatus according to claim 5, wherein:
the first mode corresponds to a monochrome plain paper print mode;
the first rotation speed is a rotation speed of said heating section that corresponds to a monochrome plain paper printing speed;
the second mode corresponds to a color special paper print mode;
the second rotation speed is a rotation speed of said heating section that corresponds to a color special paper printing speed;
the third mode corresponds to a color plain paper print mode;
the third rotation speed is a rotation speed of said heating section that corresponds to a color plain paper printing speed; and
the second rotation speed is a rotation speed of one-half or less of the third rotation speed.

14. The fixing apparatus according to claim 1, further comprising a magnetic flux generation section that generates magnetic flux according to a target temperature of said heating section,
wherein said heating section conveys heat generated by electromagnetic induction due to magnetic flux generated by said magnetic flux generation section.

15. The fixing apparatus according to claim 11, wherein:
said heat-supplying section is a magnetic flux generation section that generates magnetic flux according to a target temperature of said heating section; and
said heating section conveys heat generated by electromagnetic induction due to magnetic flux generated by said magnetic flux generation section.

16. The fixing apparatus according to claim 14, wherein said heating section is a fixing roller having at least a release layer and a heat-producing layer that produces heat by means of the electromagnetic induction.

17. The fixing apparatus according to claim 14, wherein said heating section comprises:
a fixing belt having at least a release layer and a heat-producing layer that produces heat by means of the electromagnetic induction;
a fixing roller having an elastic layer; and
a supporting roller.

18. The fixing apparatus according to claim 17, wherein said supporting roller is a heat-producing roller that produces heat by means of the electromagnetic induction.

19. An image forming apparatus comprising:
an image transfer apparatus that transfers an image to recording paper; and
a fixing apparatus,
wherein said fixing apparatus has:
a rotatable heating section that fixes by means of heat an image transferred to recording paper by said image transfer apparatus;
a pressure section that transports recording paper by means of pressure against said heating section; and
a rotation speed control section that, when a transition is made from a mode in which saidheating section rotates at a first rotation speed to another mode in which said heating section rotates at a second rotation speed, causes said heating section to rotate for a predetermined time at a third rotation speed between the first rotation speed and the second rotation speed.
